(19) United States
(12) Patent Application Publication
(10) Pub. No.: US 2010/0269093 A1
(43) Pub. Date: Oct. 21, 2010

(54) Content Management System and Method for Generating Dynamic Applications

(75) Inventor: Jefferson Walsh, Sandy, UT (US)

Correspondence Address: Patent Law Works, LLP, 165 South Main Street, Second Floor, Second Floor, Salt Lake City, UT, 84111, US

(73) Assignee: iBiz Framework, Inc., Sandy, UT (US)

(21) Appl. No.: 12/762,499

(22) Filed: Apr. 19, 2010

Related U.S. Application Data
(60) Provisional application No. 61/212,945, filed on Apr. 17, 2009.

(51) Int. Cl. G06F 9/44

(52) U.S. Cl. 717/107

(57) ABSTRACT

An application driven content management system and method for eliminating template, border and tag based restrictions found in traditional content management systems so content designers and developers are no longer restricted to targeted content areas when managing and designing content for dynamic (non-static) applications. The application driven content management system and method generally includes a visual content editing and application embedding engine, a content data store, a distribution engine, an application processing module, an application assembly and display module and an application snapshot output apparatus.

### CROSS-REFERENCE TO RELATED APPLICATION

This application claims priority under 35 USC §119(e) to U.S. provisional patent application No. 61/212,945 entitled “Application Driven Content Management System and Method,” filed Apr. 17, 2009, which is incorporated herein by reference in its entirety.

### BACKGROUND OF THE INVENTION

1. Field of the Invention

The present invention relates generally to application management systems and methods and more specifically it relates to an application driven content management system and method for eliminating template, border and tag based restrictions found in traditional content management systems so content designers and developers are no longer restricted to targeted content areas when managing and designing content for dynamic (non-static) applications.

2. Description of the Related Art

In traditional content management systems, webpages and desktop applications are designed by inserting content markers into designated areas. The rest of the webpages and desktop applications contain fixed and unchangeable areas. During runtime, the rendering engine replaces the content markers with content from a repository. This system is very limiting because the developer can only change the defined areas where content markers can be inserted.

In addition, when a developer wants to create a webpage with skins that are similar to a pre-existing website, the developer must recreate the functional component by writing the appropriate code. This is time consuming and seemingly unnecessary when the code has already been created for the pre-existing website.

What is needed is a more flexible system where all areas of the application can be managed. What is also needed is a system for capturing content from websites and incorporating it into a dynamic application.

### SUMMARY OF THE INVENTION

The present invention provides a system and method for generating dynamic application content through the use of application markers. The content application system comprises an application embedding engine, a content data store, a distribution engine, an application processing module, an application assembly and display module and an application snapshot output module.

In one embodiment, the present invention comprises a method for generating a dynamic application by creating content responsive to user input, retrieving an application snapshot from a data store, capturing an application marker from the application snapshot, embedding the application marker into the content, binding the application marker to a functional component to generate a bound application component, rendering the bound application component and content to generate a rendered bound application and outputting the rendered bound application components as an output snapshot.

In one embodiment of the invention, the system and method of the present invention allow all content areas to be modified when managing and designing content for dynamic (non-static) applications.

In another embodiment of the invention, the system and method of the present invention allow content designers and developers to modify and preview their content without the presence of the dynamic application for which their content is being developed.

In yet another embodiment of the invention, the system and method of the present invention does not require “content markers” or “tags” to be present in the dynamic application for which the content is being developed.

The system and method of the present invention allow content designers and developers to embed application markers that represent the functional components of the application within their content without having to know how those application components work together in the target dynamic application.

The system and method of the present invention includes a distribution engine for distributing content from the application embedding engine to the dynamic application engine. This removes the need for content to be “pulled” from a content data store at the time it is assembled and displayed by automatically distributing the content to the dynamic application engine before it is requested.

Other advantages of the present invention will become apparent to the reader and it is intended that these advantages are within the scope of the present invention. To the accomplishment of the above and related embodiments, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1a is a block diagram illustrating one embodiment of a content management system for generating a dynamic application.

FIG. 1b is a block diagram illustrating a second embodiment of a content management system for generating a dynamic application.

FIG. 2a is a graphical representation of a graphical user interface generated by the present invention.

FIG. 2b is a graphical representation of a preview generated by the present invention.

FIG. 2c is a graphical representation of a pop-up box for selecting control elements to be inserted into the content according to one embodiment of the present invention.

FIG. 2d is a graphical representation of a pop-up box for selecting application markers within a control element to be inserted into the content.

FIG. 2e is a graphical representation of different items that can be inserted into the code according to one embodiment of the present invention.

FIG. 2f is a rendered bound application according to one embodiment of the invention.

FIG. 2g is a flow diagram that illustrates the process of generating a preview with the application embedding engine according to one embodiment of the present invention.

FIG. 3 is a block diagram illustrating the functional elements contained in a data store according to one embodiment of the present invention.

FIG. 4 is a block diagram illustrating the components of a distribution engine.

FIG. 5a is a flow diagram illustrating one embodiment for rendering and binding application markers.

FIG. 5b is a block diagram illustrating one embodiment of the application assembly and display module.

FIG. 6a is a block diagram of one embodiment of the present invention that illustrates the differences between content markers and application markers as well as how their use impacts a content developer's overall level of control in managing an application.

FIG. 6b is a block diagram that illustrates the differences between generating a preview of a page and rendering the application according to one embodiment of the invention.

FIG. 6c is a block diagram that illustrates one embodiment of the components used during rendering.

FIG. 7 is a flow diagram illustrating one embodiment of a process for transmitting application markers and content through an n-tier system.

FIG. 8 is a flow diagram illustrating one embodiment of a method for generating a dynamic application.

FIGS. 9a-9b are a flow diagram illustrating a second embodiment of a method for generating a dynamic application.

### DETAILED DESCRIPTION OF THE INVENTION

A content management system and method for generating dynamic application content through the use of application markers is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. For example, the present invention is described in one embodiment below with reference to user interfaces and particular hardware. However, the present invention applies to any type of computing device that can receive data and commands, and any peripheral devices providing services.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

### A. System Overview

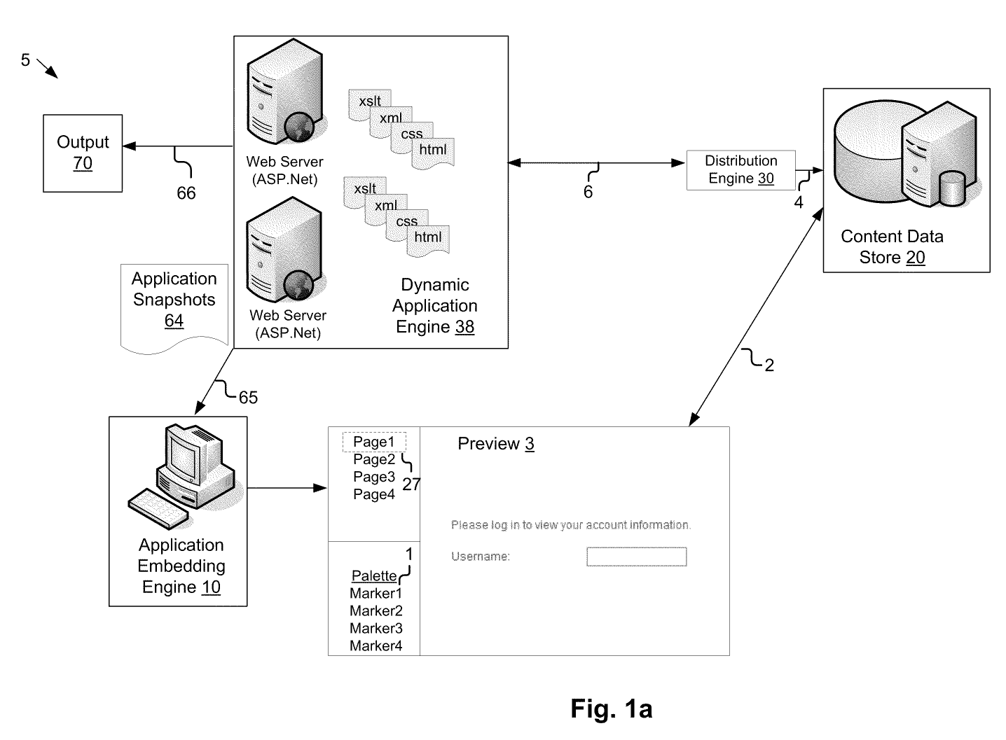

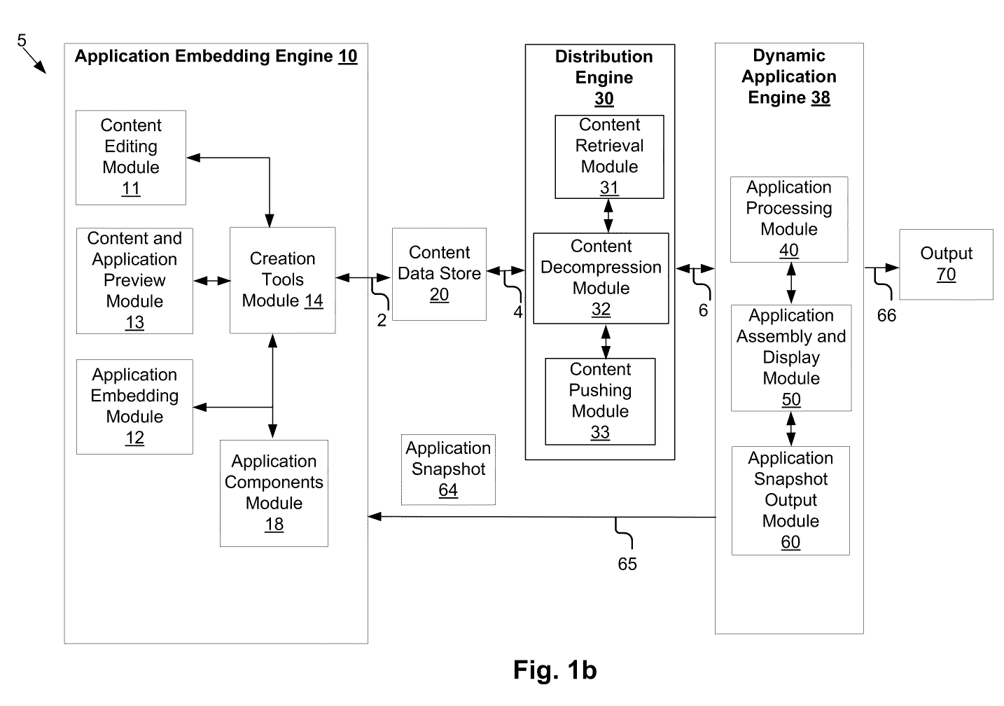

FIG. 1a illustrates a block diagram of a first embodiment of a system (5) for generating dynamic applications according to one embodiment of the invention. The system (5) includes an application embedding engine (10), a content data store (20), a distribution engine (30), a dynamic application engine (38) and output (70).

The application embedding engine (10) generates content, application markers (1) and application definitions. The application embedding engine (10) embeds application markers (1) into the content. The application embedding engine (10) includes a computer having a processor for executing routines and a module for generating a preview (3) of page 1 (27) of the dynamic application.

The application definitions, content and embedded application markers generated by the application embedding engine (10) are transmitted to a content data store (20) via a communications bus (2). In one embodiment of the invention, the content is compressed as .Net Zip Library files transmitted as a Simple Object Access Protocol (SOAP) message.

The distribution engine (30) retrieves the application definitions, content and embedded application markers from the content data store (20) via communications bus (4), decompresses the application definitions, content and embedded application markers and pushes them to a dynamic application engine (38) via communications bus (6). The dynamic application engine (38) includes web server computers that are running ASP.Net. In this embodiment, the .Net Zip Library files are decompressed to form a variety of formats including html, css, xml and xslt. The dynamic application engine (38) processes the content, identifies the application markers (1), binds the application markers (1) to the functional components and renders the dynamic application. The rendered application is transmitted as output (70) via communications bus (66).

The dynamic application engine (38) takes an application snapshot (64) of the dynamic application and transmits the application snapshot (64) to the application embedding engine (10) via communications bus (65), which is then embedded into the content and then transmitted to the content data store (20). The application snapshot (64) serves as a reference for future changes to the application. Although FIG. 1a illustrates the system using a Microsoft ASP.Net dynamic application, persons of ordinary skill in the art will recognize that in another embodiment of the invention, a different application framework is used.

FIG. 1b illustrates a block diagram of a content management system for generating dynamic applications according to one embodiment of the present invention. The system (5) includes an application embedding engine (10), a content data store (20), a distribution engine (30), a dynamic application engine (38) and output (70).

The application embedding engine (10) is communicatively coupled to a content data store (20) through a communications bus (2), which saves output generated by the application embedding engine (10). The distribution engine (30) acts as an intermediary between the dynamic application engine (38) and the content data store (20) by retrieving data from the content data store (20) via a communications bus (4) and transmitting the data to the dynamic application engine (38) via a communications bus (6). The dynamic application engine (38) is communicatively coupled to the distribution engine (30) and includes an application processing module (40), an application assembly and display module (50) and an application snapshot output module (60). The dynamic application engine (38) generates output (70) that is received by an end user via communications bus (66) in the form of, for example, a website or winform.

### B. The Application Embedding Engine (10).

Still referring to FIG. 1b, the content editing and application embedding engine (10) includes a content editing module (11), an application embedding module (12) for embedding application markers within content, a content and application preview module (13) for simulating application processes, a creation tools module (14) for compressing and saving the content to storage and an application components module (18). The application embedding engine (10) allows content developers to visually edit and preview their content as though it were being processed and displayed by the target dynamic application itself. Once the content development process is finalized, the application definitions, the embedded application markers and the content are stored on a content data store (20).

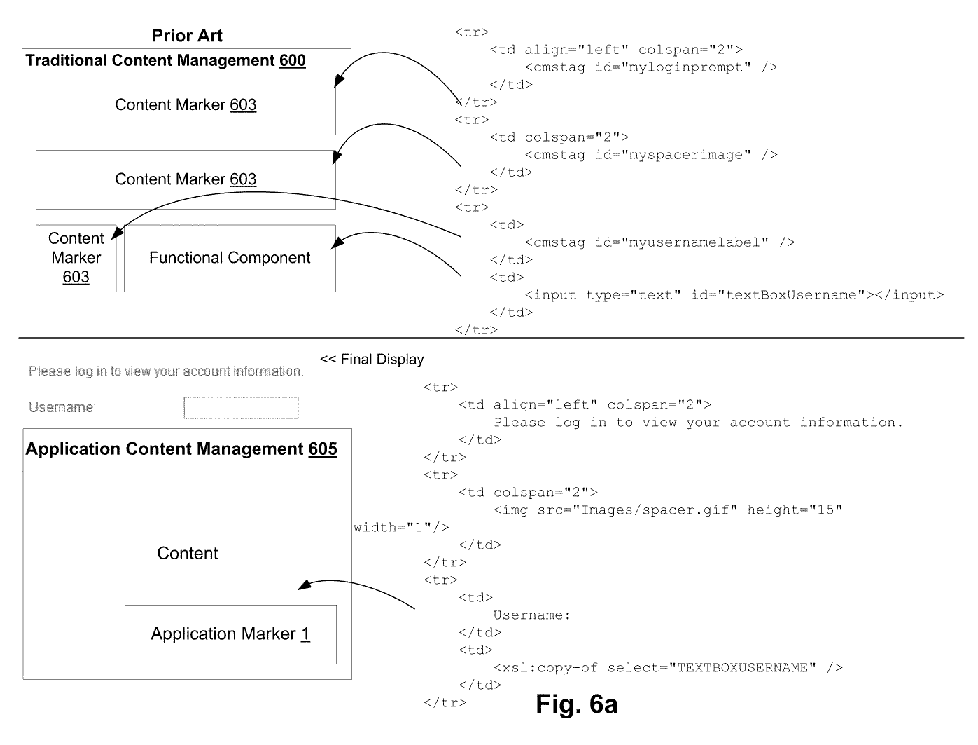

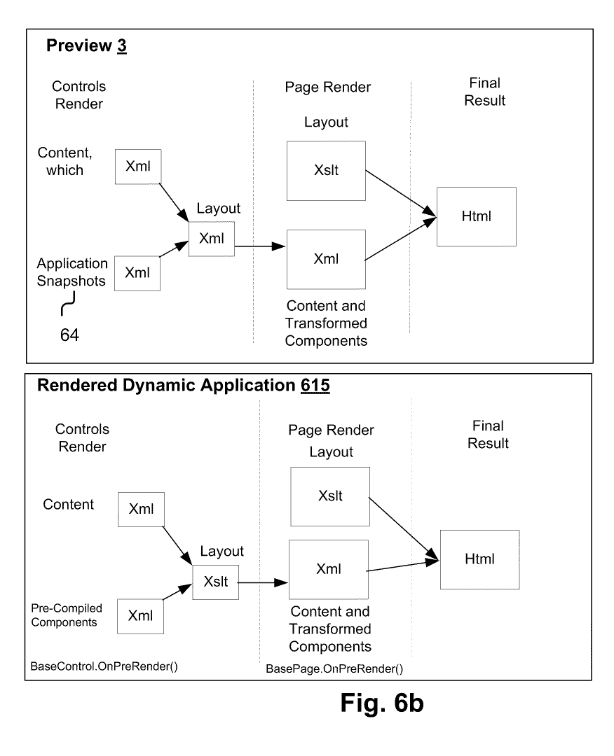

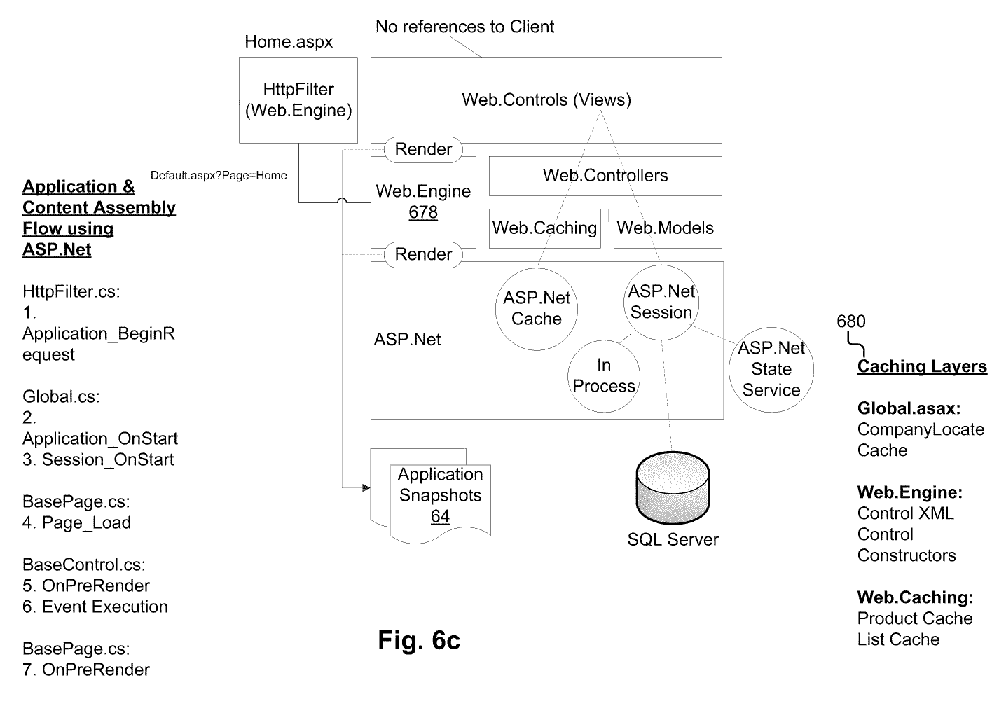

In one embodiment, the application embedding engine (10) receives application snapshots (64) via communications bus (65) from a dynamic application engine. These application snapshots (64) allow content developers to visually build their target dynamic application using the content editing module (11) without having to know how its functional application components work because the application embedding module (12) captures the application markers (1) for the functional elements from the application snapshots (64) and embeds them into user-generated content. The content editing module (11) also eliminates template and border based restrictions on content management by embedding the application markers (1) into the content rather than embedding content into application components. This process is described in greater detail below in conjunction with FIG. 6a. The application components module (18) generates application definitions that define the flow of pages so that they can be properly assembled at runtime. Lastly, the creation tools module (14) compresses the application definitions, the content and the embedded application markers, which are transmitted to the content data store (20) via communications bus (2) for storage.

A preferred embodiment for the dynamic application engine (38) is a Windows desktop application written in Microsoft C#.Net. The views for the target dynamic application (pages for web applications and forms for desktop applications) are displayed visually on the left and allow the user to navigate the target dynamic application easily.

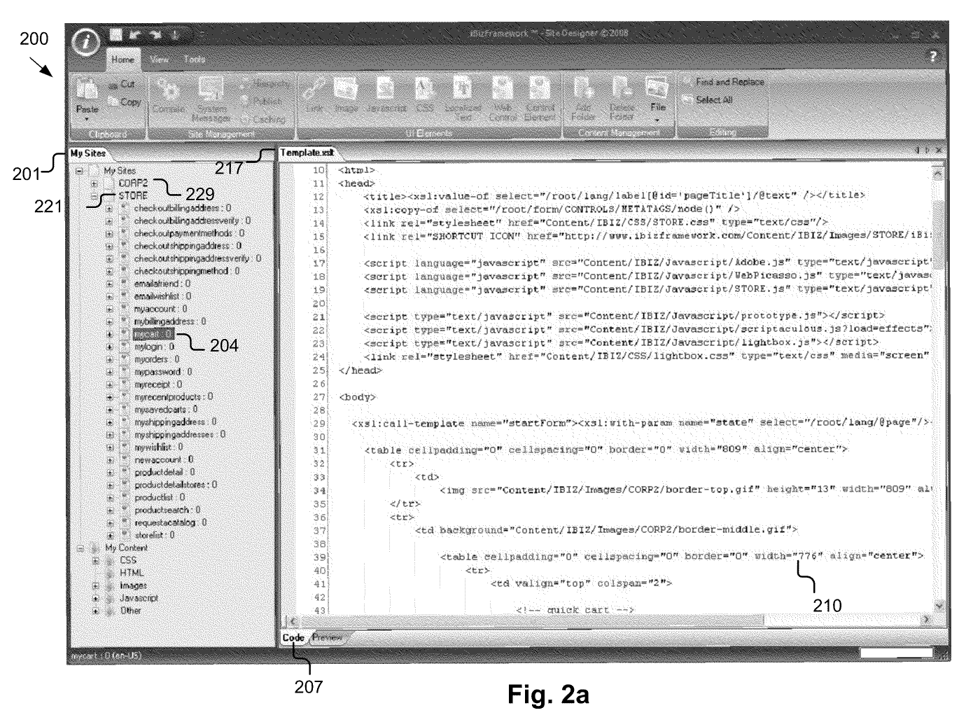

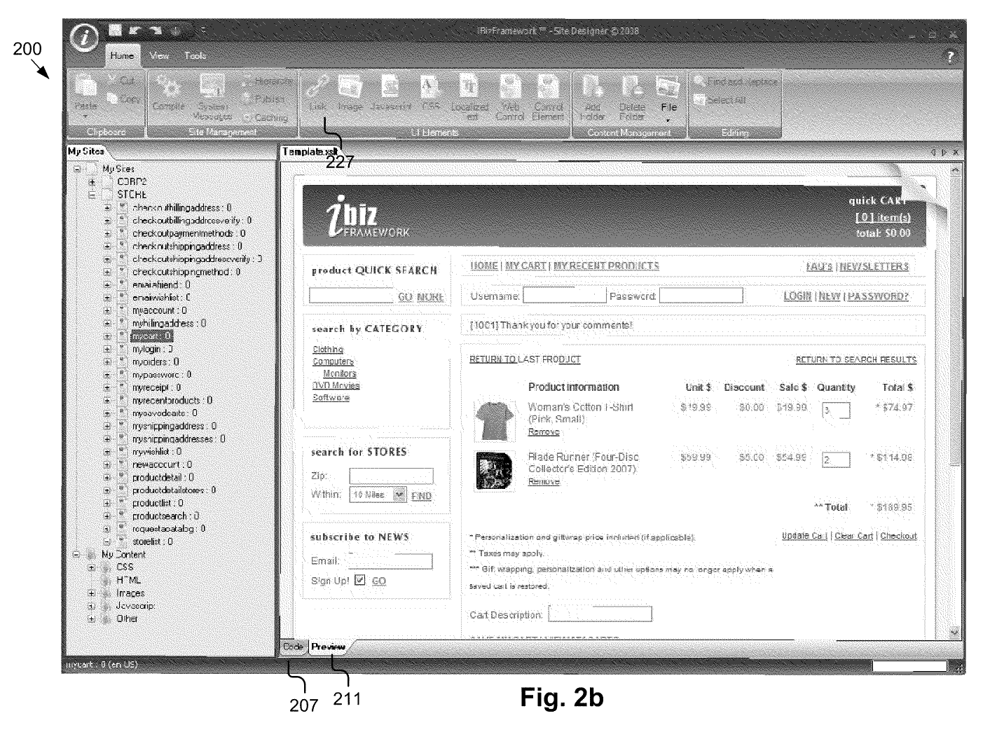

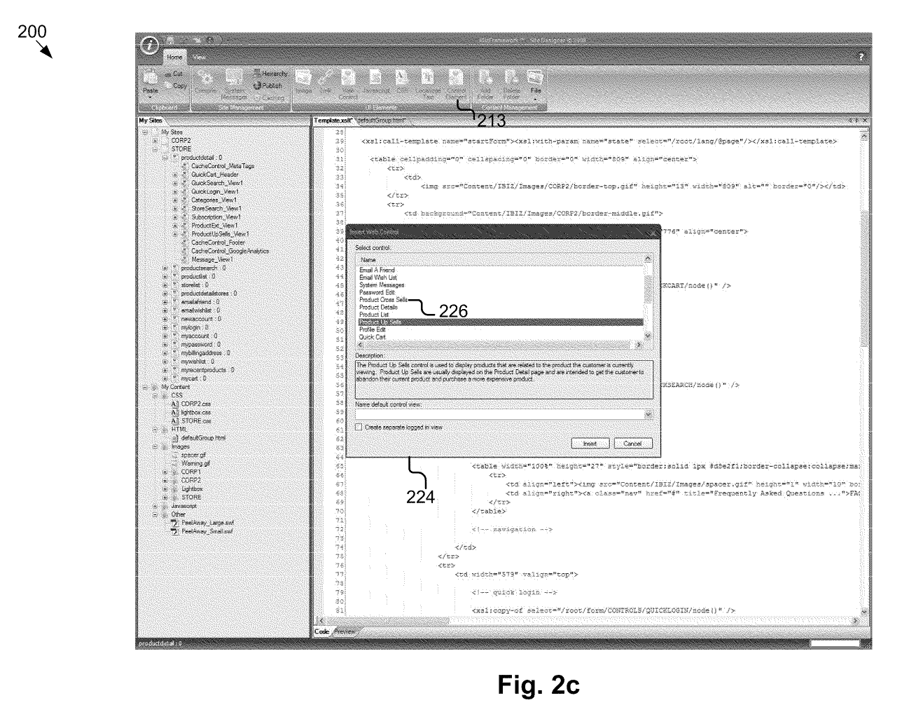

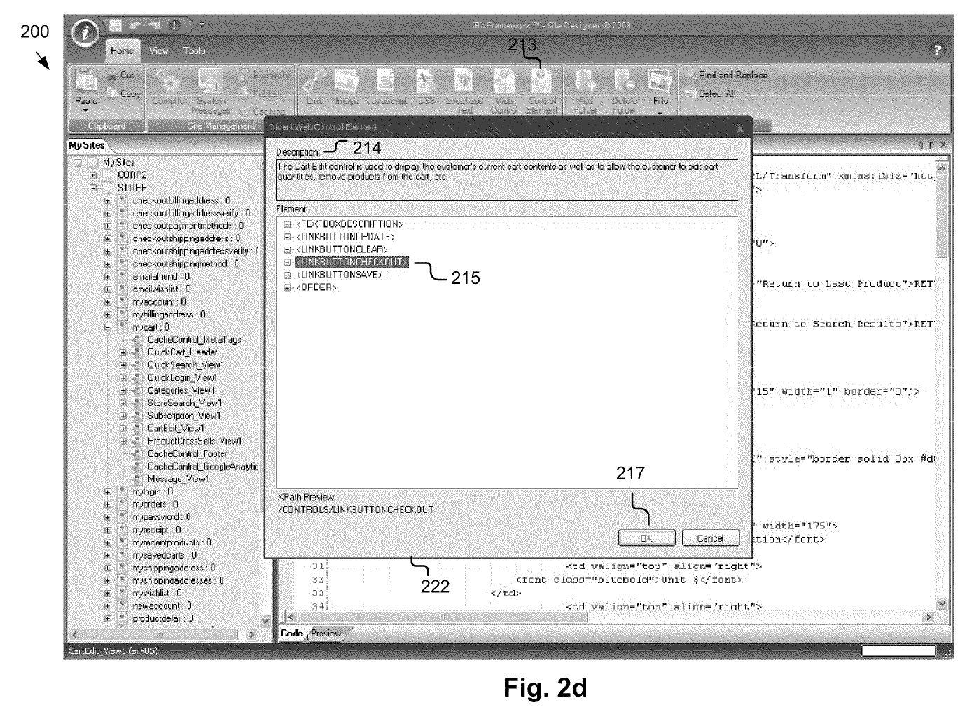

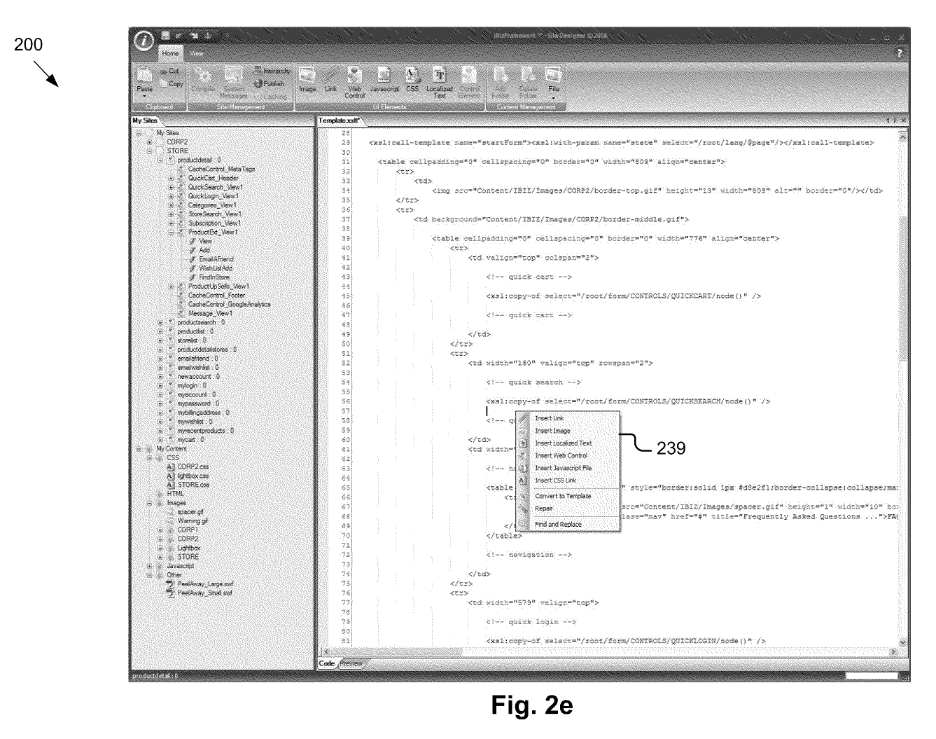

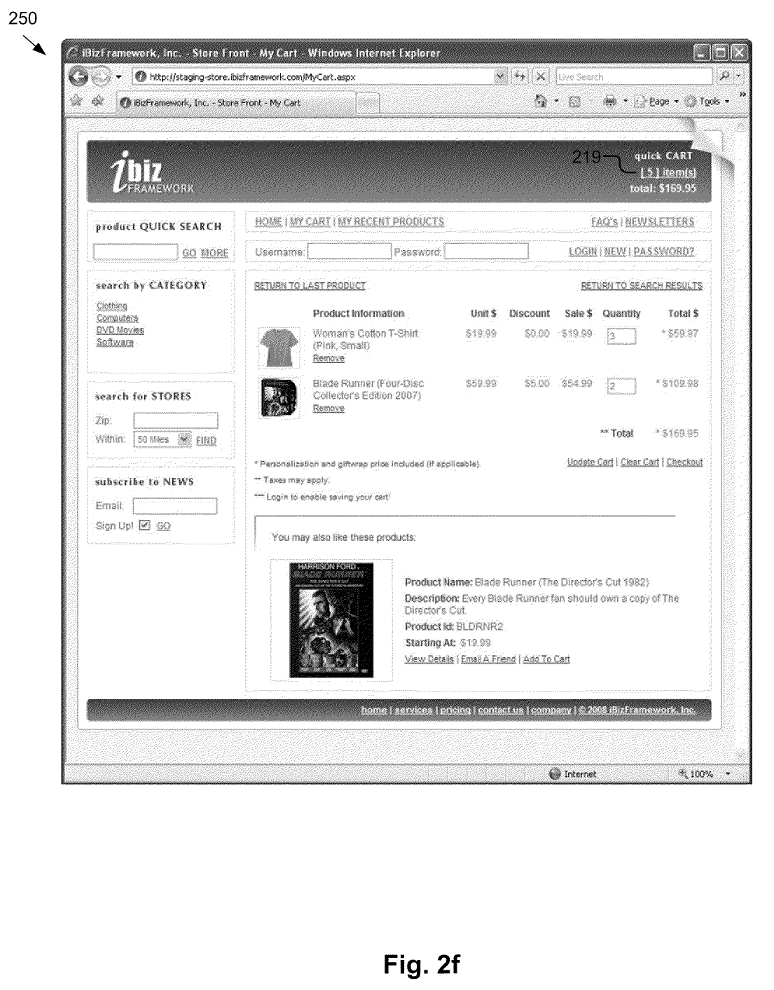

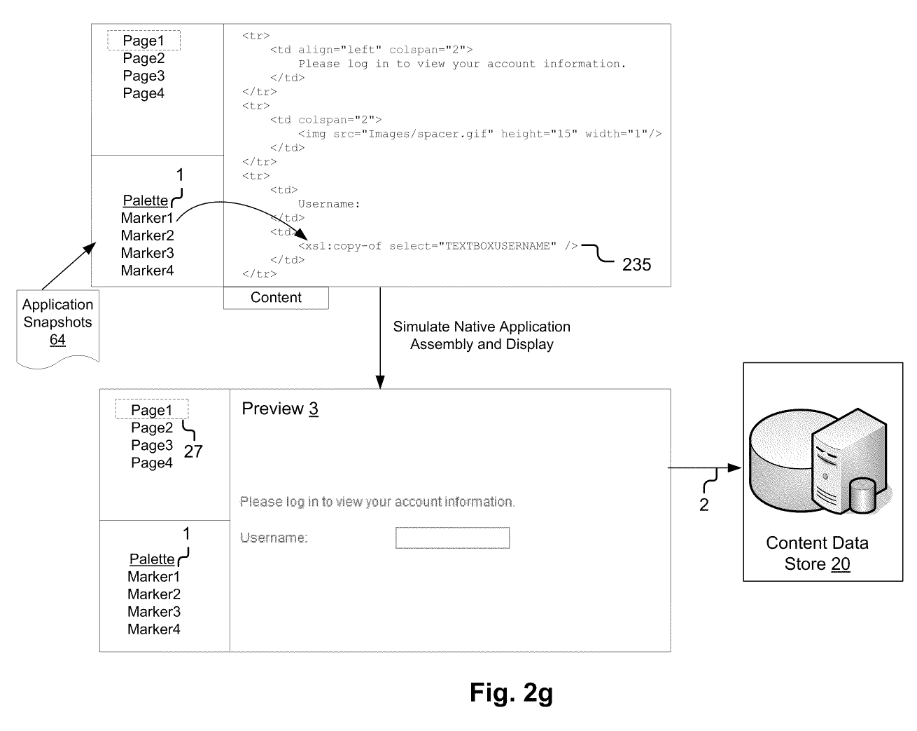

In one embodiment, the user can switch between a source version and a rendered version of the current view's content. FIG. 2a is an example of a graphical user interface (200) source version of the content. The left-hand side of the screen, which is labeled My Sites (201), contains a list of the different skins (or “look and feels”) within a dynamic application. Here, the two skins are CORP2 (229) and STORE (221). The skins contain the application definitions and application views (or screens). The skins expand to display a list of the different application views (or screens) (204). The right side of the screen, which is labeled Template.xslt (217), displays the code or the preview of the application view, depending upon which tab is selected. To view the code (210) associated with each application view (or screen), the user selects the code tab (207) and the code appears on the right. In this example, the code for mycart (204) appears on the right-hand side of the interface.

Switching to the rendered version of the content triggers the content application and preview module (13) to generate a preview of the content in its target application. FIG. 2b illustrates a graphical user interface (200) that displays a preview of the current view's content in the pane on the right side of the graphical user interface. To switch between the code and the preview, the user selects the code (207) and preview (211) tabs on the bottom of the user interface (200). The preview is not an active version of the website. Thus, the links are not active. Instead, this view allows the user to anticipate the appearance of the cart and how it relates to other application markers in the webpage.

The user can also add new views or remove existing views from the target application as well as define how views transition between one another using other tools displayed in the graphical user interface, such as the link icon (227). Additionally, when viewing the source of the content, the application embedding module (12) embeds functional application components like search buttons, password text boxes and country drop down lists into the content as application markers.

FIG. 2c is a graphical representation of a graphical user interface (200) for selecting user controls through the use of a pop-up window (224) according to one embodiment of the invention. A user selects the control element icon (213), which causes a list of user controls to appear. The user selects the user control, such as product cross sells (226) and inserts the user control into the code.

FIG. 2d is a graphical representation of a graphical user interface (200) for embedding application markers (1) through the use of a pop-up window (222). A user selects the control element icon (213), which causes a list of application markers (1) to appear. Each component application marker (1) is associated with a description that appears in the description box (214) when the application marker (1) is highlighted. In this example, the user has selected the <LINKBUTTONCHECKOUT> icon (215) to place a checkout button on the mycart view (screen). Once the icon is highlighted, the user clicks the okay icon (217). This inserts the application marker (1) into the content. Once the application definitions, content and the embedded application markers are transmitted to the dynamic application engine (38), the application marker (1) is associated with the functional component and during rendering becomes active.

In one embodiment, application marker embedding can be achieved through the use of eXtensible Stylesheet Language Transformations (Xslt). Persons of ordinary skill in the art will recognize that other languages can be used to achieve the same purpose. The application embedding engine (10) consumes application snapshots (64) to determine which application markers (1) are available for embedding. The application embedding module (12) inserts application markers (1) into the content by placing Xslt tags in those locations so that during rendering the dynamic application engine (38) replaces the Xslt tags with functional components.

FIG. 2e is a graphical representation of a graphical user interface (200) of different items that can be inserted into the code according to one embodiment of the present invention. In this example, the user directly inserts code associated with links, images, localized text, web controls, Javascript files or CSS links by right-clicking on a mouse to reveal a pop-up box (239) that displays these options.

FIG. 2f is a graphical representation of a website (250) at runtime where the application markers (1) for the items and the quick cart were embedded and are active. In this example, the item icon (219) is now linked to the quick cart. Because five items have been selected, the item icon (219) now shows that there are five items in the quick cart. In one embodiment of the invention, the application markers (1) are denoted with Xslt tags.

FIG. 2g is a graphical representation of the process for generating a preview (3) of page 1 (27) of a dynamic application according to one embodiment of the present invention. The application markers (1) are extracted from the application snapshots (64) and embedded into the code (235). To generate a preview (3), the content and application preview module (13) simulates native application assembly and display. The links in the preview are not active, but the user is able to preview the general appearance of the page. In one embodiment, the previews are transmitted to the content data store (20) for storage via communications bus (2).

In another embodiment of the invention, the application embedding engine (10) retrieves application snapshot files directly from the dynamic application engine (38) at runtime rather than utilizing locally stored snapshots when the application embedding module (12) performs application definition embedding.

Once the content editing and application embedding process is complete, the creation tools module (14) compresses the content and saves it to the content data store (20) via communication bus (2).

### C. Content Data Store (20).

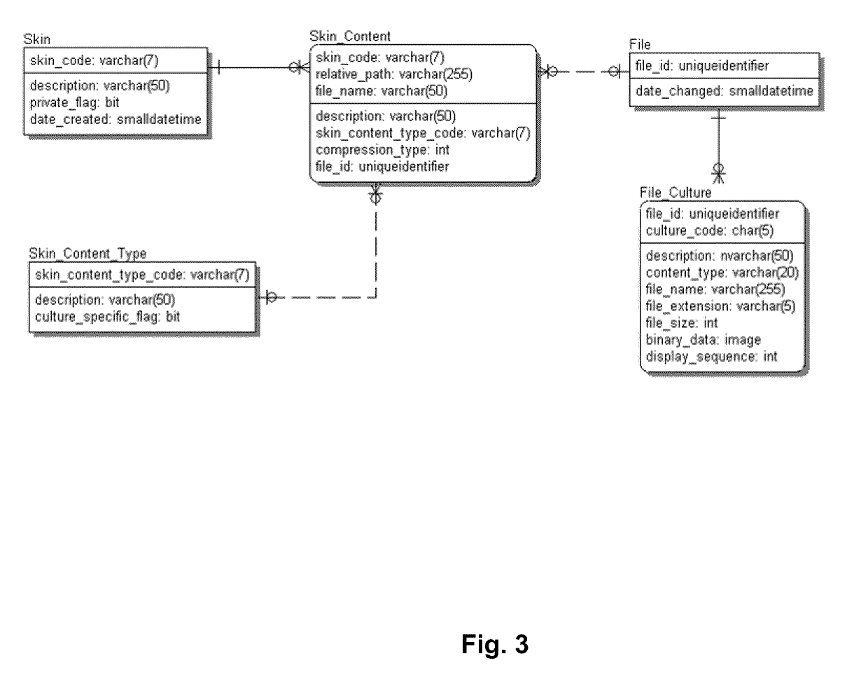

The content data store (20) retains centralized copies of content, application definitions, embedded application markers and application processing instructions as files. FIG. 3 is an example of a data model in which the files are stored in the content data store (20). In one embodiment, the content data store (20) is used by the distribution engine (30) to retrieve and distribute content with embedded application markers and application definitions as files to the application processing module (40) and the content and application assembly and display module (50).

The content data store (20) is a repository used to store files that are created or modified by the application embedding engine (10). In one embodiment, the content data store (20) is used to store the files because the target dynamic application that consumes the files exists in many locations and a centralized location facilitates mass distribution of the files.

When files are stored in the content data store (20), binary and textual data is stored for the file as well as its content type (Xml, Xslt, Html, Css), file name, file extension, description, compression type and relative path within the target dynamic application.

In one embodiment of the invention, a Microsoft SQL Server database contains tables, such as the ones illustrated in FIG. 3. General access to the data is performed by interfacing with stored procedures through standard Microsoft C#.Net business and data application layers.

In another embodiment, the elements are created using other forms of repositories that are not directly considered “databases.” For example, Xml files or proprietary binary storage files could be used to store the same type of information as a “database” and therefore could be used to replace this element.

### D. Distribution Engine (30).

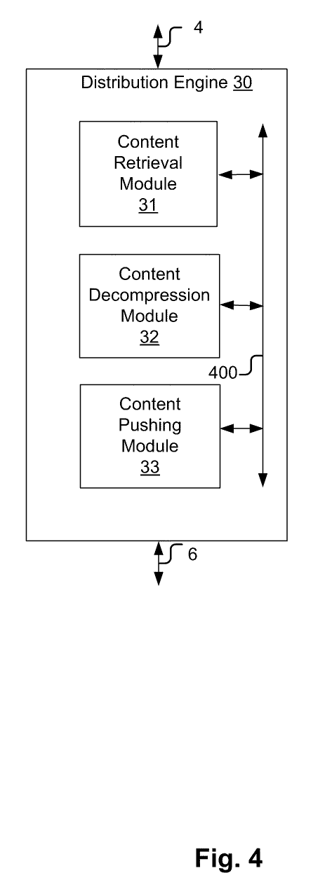

The distribution engine (30) distributes content and application definitions to the dynamic application engine (38) via communication bus (6). FIG. 4 is a block diagram illustrating the components of a distribution engine (30). These modules (31-33) are communicatively coupled to each other via a communication bus (400). The distribution engine (30) includes a content retrieval module (31), a content decompression module (32) and a content pushing module (33). The content retrieval module (31) finds newly created content that was stored in the content data store (20) by the application embedding engine (10). The content decompression module (32) decompress the content. The content pushing module (33) pushes the content to the dynamic application engine (38) via communications bus (6), which will process, assemble and display the content for the user.

In one embodiment, the content retrieval module (31) is scheduled to wake up at regular intervals and check the content data store (20) for newly updated content and application definition related files. When new files are identified in the content data store (20), the content retrieval module (31) retrieves the files and sends the files to the content decompression module (32). The content decompression module (32) decompresses the files and sends them to the content pushing module (33). The content pushing module (33) places them local to the application processing module (40) and the application assembly and display module (50). Because the distribution engine (30) retrieves content, embedded application markers and application definition files for the application processing module (40) and the application assembly and display module (50), in one embodiment of the invention, the distribution engine (30) and the dynamic application engine (38) are stored on the same computer or server. In another embodiment, the distribution engine (30) and the dynamic application engine (38) are stored on the same local network.

In one embodiment, the distribution engine (30) is a Microsoft Windows service written in Microsoft C#.Net that runs unattended on a scheduled basis on the same computer as the dynamic application engine (38). If the dynamic application engine (38) is a Microsoft ASP.Net web application, the distribution engine (30) runs on the web server where the Microsoft ASP.Net web application is also running.

In another embodiment, the distribution engine (30) is remotely located from the dynamic application engine (38). For example, the content, embedded application markers and application definition files are retrieved in real time from a web service at a remote location or the dynamic application engine (38) retrieves the content and application definition files at startup from a remote location.

In yet another embodiment, the modules and specialized computing machines are adapted to perform the functions above.

### E. Dynamic Application Engine (38).

Referring back to FIG. 1b, the dynamic application engine (38) generates the output (70) for a user in the form of a dynamic application and an application snapshot (64) for the application embedding engine (10). The output (70) is transmitted to a user via communications bus (66). The application snapshot is transmitted to the application embedding engine (10) via communications bus (65). The dynamic application engine (38) comprises an application processing module (40), an application assembly and display module (50) and an application snapshot output module (60).

The application processing module (40) includes application marker identification and performs application component binding. The application processing module (40) examines content for embedded application markers and processes the application markers (1) by binding them with functional application components and associating those components with their respective application logic so they can execute and play an active role in the dynamic application.

The application processing module (40) is an integral part of the dynamic application engine (38). It is one of two key building blocks on which the system (5) depends in order to consume content, embedded application markers and application definition files produced by the content editing and application embedding engine (10). The application processing module (40) identifies application definition files and searches application content for embedded application markers so that it can bind the appropriate application components to the environment's native runtime engine.

In traditional content management systems, this component would instead be looking for content markers and would be replacing those markers with content from a repository at runtime. One premise of the traditional content management model is that the application itself is fixed and unchanging while tagged or marked areas of content are inserted at set locations, creating a very rigid framework with which the content developer can work.

The application processing module (40) allows the entire application to be assembled at runtime and because the content itself is the container for the application markers, the content is free from tag or marker based design restrictions.

The application processing module (40) can take many forms. Its purpose is to give complete control (at runtime without recompiling the target dynamic application) to a content developer over not just how the application looks but also how it behaves and how it functions. This is achieved in different ways depending on the target dynamic application's underlying technology (.Net, Java, ColdFusion, etc) and platform (Windows Desktop, Windows Web Server, Mac Desktop, etc). As a result, this component will be structurally different depending on the underlying technology being used and the platform being targeted.

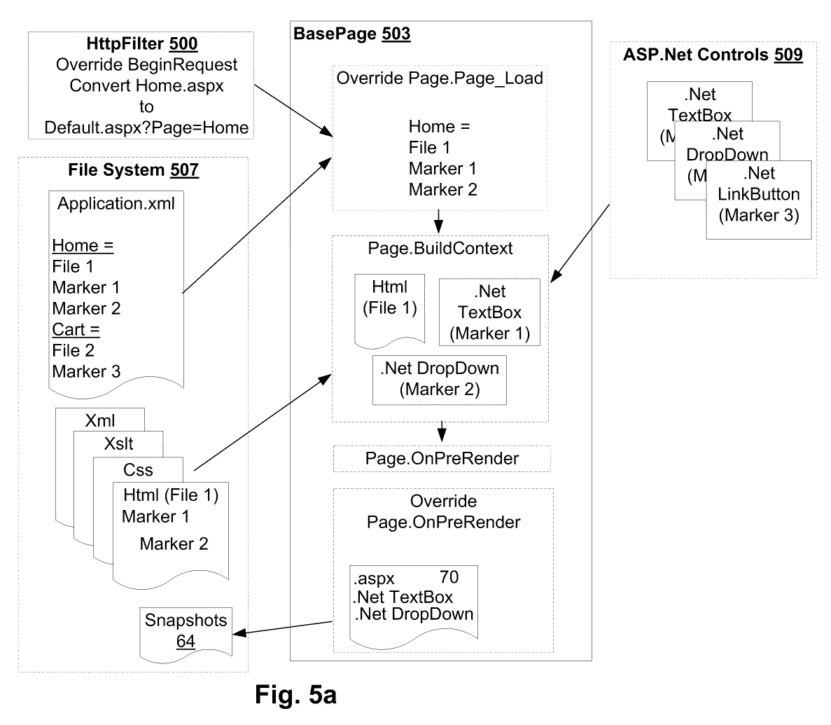

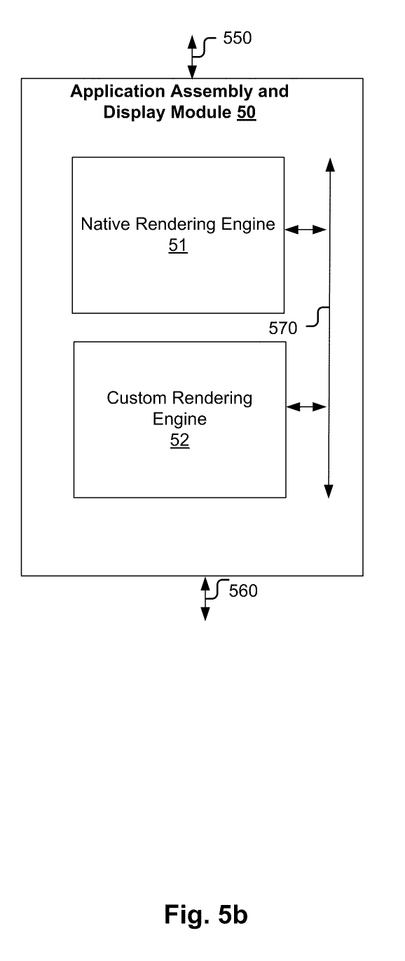

FIG. 5a is a flow diagram that illustrates the flow of information created by the application processing module (40) and the application assembly and display module (50). An HttpFilter (500), which is a component of the web engine, transmits an override begin request to the base page (503), which is a class file. In this example, the override BeginRequest instructs the application processing module (40) to convert the web request for Home.aspx to Default.aspx?Page=Home. The File System (507) transmits application markers (1) to the BasePage (503).

The BasePage (503) receives functional components in the form of ASP.Net Controls (509) and content from the file system (507) along with application markers (1). The application processing module (40) uses this information to bind application components to the embedded application markers. The output (70) is cached for subsequent use and is transmitted to the file system (507) as an application snapshot (64).

In yet another embodiment, the modules and specialized computing machines are adapted to perform the functions above.

### F. Application Assembly and Display Module (50).

FIG. 5b is a block diagram illustrating the application assembly and display module (50). The application assembly and display module (50) includes a native rendering module (51) and a custom rendering module (52). The application assembly and display module (50) receives the bound application components from the application processing module (40) via communications bus (550) and transmits bound application components to the application snapshot module (60) via communications bus (560). The modules communicate with each other using a communication bus (570).

The custom rendering engine (52) injects managed content from the application embedding engine (10) and rendered content from bound application components into the native rendering engine (51). The output is transmitted to the application snapshot output module (60) via communications bus (560). In FIG. 5a, the native environment rendering is illustrated in the BasePage (503) with the Page.OnPreRender display mechanism. The customized rendering is illustrated in FIG. 5a on the BasePage (503) by the Override Page.OnPreRender display mechanism.

The application assembly and display module (50) supplements the target dynamic application's display mechanism so that content, application markers and bound application components from the application embedding engine (10) are consumed by the target dynamic application at runtime.

In one embodiment, the dynamic application engine (38) utilizes a Microsoft C#.Net class library for customized rendering that overrides the native ASP .Net rendering process in an ASP.Net web application. The class library reads definition files to determine which content and bound components are relevant to the context of the current user visiting the ASP.Net web site, gathers the content, leverages the underlying ASP .Net engine to render the bound components, packages the results and passes it down to the underlying ASP.Net engine to finalize the output (70) for the user.

FIG. 6a is a block diagram that illustrates a comparison between a traditional content management system that uses content markers (603) and an application content management system (605) that uses application markers (1). In traditional content management systems (600) (prior art), there are no application markers (1). Instead, the pages (in the case of web applications) and forms (in the case of desktop applications) for the target dynamic application are predefined when the application is created and are not changeable at runtime. As a result, content can only be injected where content markers (603) have been placed. This is illustrated in FIG. 6a with arrows from the code to the content markers (603).

In an application content management system (65), on the other hand, application markers (1) are inserted anywhere. The system (5) does not have predefined pages or forms. Instead, the system creates, assembles and displays pages or forms at runtime that provide greater flexibility to content developers. Instead of dividing up the content according to content markers (603), application markers (1) are embedded into the content, associated with functional components and rendered as bound components at runtime.

Like the application processing module (40), the application assembly and display module (50) takes many forms depending on the target dynamic application's underlying technology (.Net, Java, ColdFusion, etc.) and platform (Windows Desktop, Windows Web Server, Mac Desktop, etc). As a result, this component is structurally different depending on the underlying technology being used and the platform being targeted.

### G. Application Marker (“Snapshot”) Output Module (60).

Referring back to FIG. 1b, the application snapshot output module (60) includes an interception mechanism, a markup component and an output mechanism for generating an application snapshot (64). The application snapshot output module (60) intercepts application output prior to its display, packages or “marks up” the intercepted output and transmits it as an application snapshot (64) to the application embedding engine (10) via communications bus (65). The application snapshot (64) is then incorporated directly into the content.

In one embodiment, the application snapshot output module (60) is a logging component built into the work flow of the application assembly and display module (50) that is used to capture the appearance of application components at runtime.

During the custom rendering process of the application assembly and display module (50), the application snapshot output module (60) intercepts the rendered results, wraps the results in tags (for example, Xml tags) and outputs the combined results as application snapshots (64) (for example, Xml files) for later use by the application embedding engine (10).

In one embodiment, the application snapshot output module (60) uses a Microsoft C#.Net class library that is invoked during the custom rendering process of the application assembly and display module (50).

FIG. 6b is a block diagram that illustrates the process for generating a preview (3) with the content and application preview module (13) and the process for generating a rendered dynamic application (615) with the application assembly and display module (50) according to one embodiment of the invention. The application embedding module (12) inserts application markers (1) from the application snapshot (64) into the content. The content and application preview module (13) renders the content and transformed components to generate a preview. The final result allows the user to view a preview (3) of the dynamic application.

The process for rendering a dynamic application uses components that are pre-compiled by the application assembly and display module (50). The pre-compiled components are combined with the content, which is rendered by the application assembly and display module (50) to generate a final result. The final result is an active dynamic application.

FIG. 6c is a block diagram that illustrates an example of the rendering process on a web engine running within ASP.Net according to one embodiment of the invention. The web engine (678) renders the bound application components and content and generates application snapshots (64). Portions of the rendered components that do not contain user specific data are cached permanently. Rendered components can be cached in three areas (680), the ASP.Net application file (Global.asax), the web.engine class (web.engine) and the web.caching class (web.caching).

### H. Methods

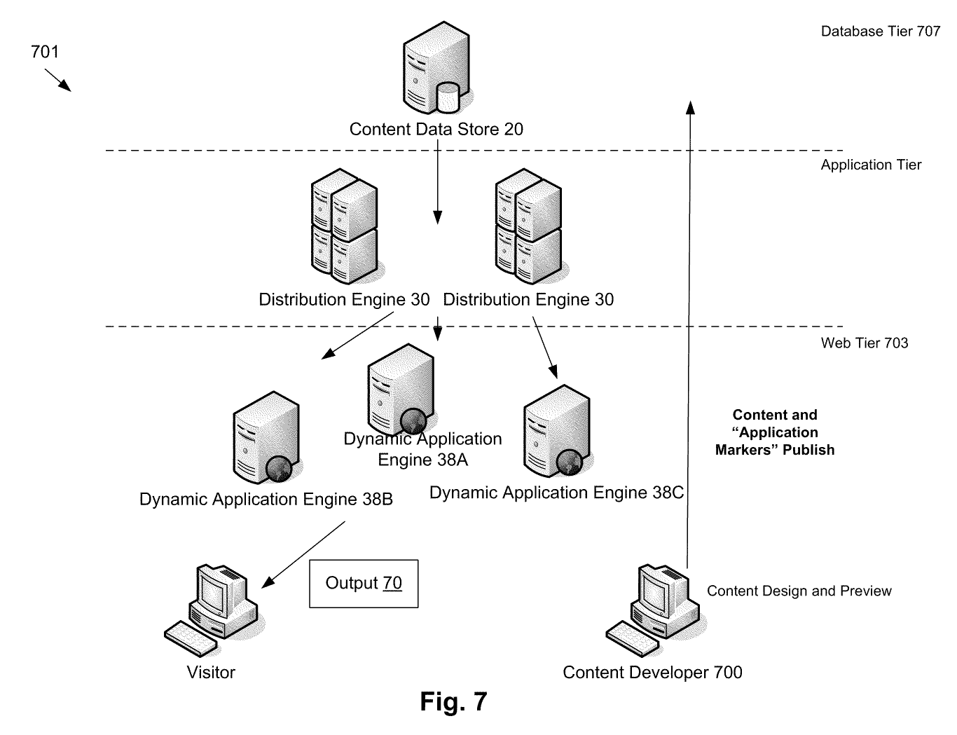

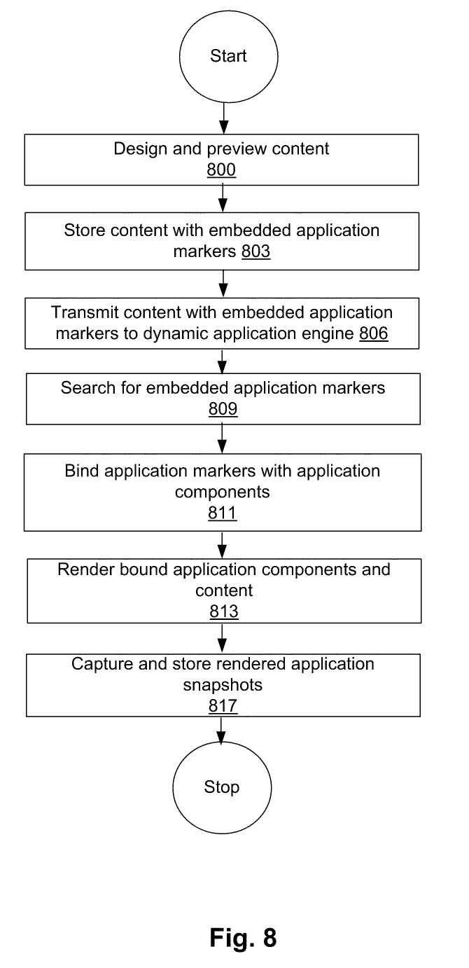

Referring now to FIGS. 7-9, various embodiments of the method of the present invention will be described. FIG. 7 is a flow diagram that illustrates the transmission of content and application markers through an n-tier system (701) according to one embodiment of the invention. FIGS. 8a-b are a flow chart that describes the same method. These figures will both be referred to in the following text. Starting with the content developer (700) in the Web tier (703), the content developer (700) designs content and previews (800) the appearance of content on, for example, a website or a desktop application. The content and embedded application markers are stored (803) in the content data store (20) in the database tier (707).

The distribution engine or engines (30) transmit (806) the content and embedded application markers to the dynamic application engine (38). The dynamic application engine (38) searches (809) for embedded application markers and prepares the dynamic application engine (38) for rendering by binding (811) application markers with application components.

The custom rendering engine (51) renders (813) bound application components and content of the target dynamic application for display to the end user.

During the rendering process performed by the application assembly and display module (50), the application snapshot output module (60) captures and stores (817) rendered application snapshots so they can be used by the application embedding engine (10) to further modify and redesign the target dynamic application.

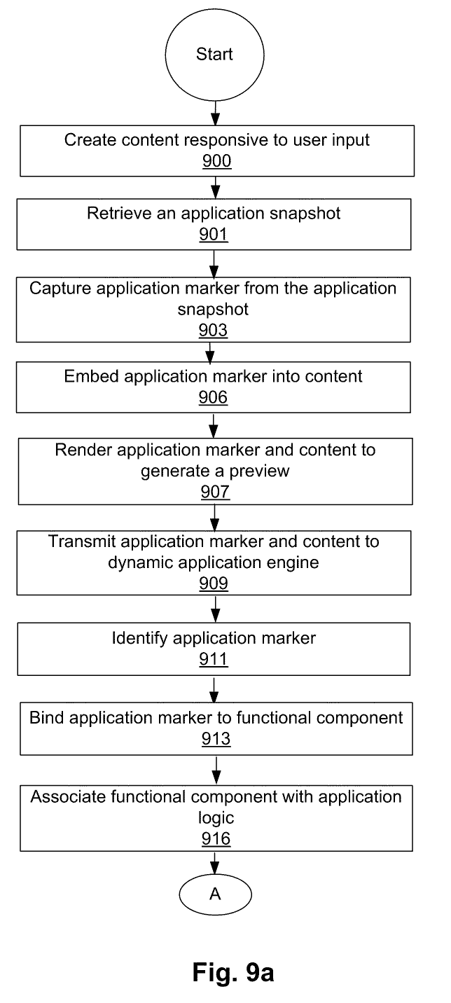

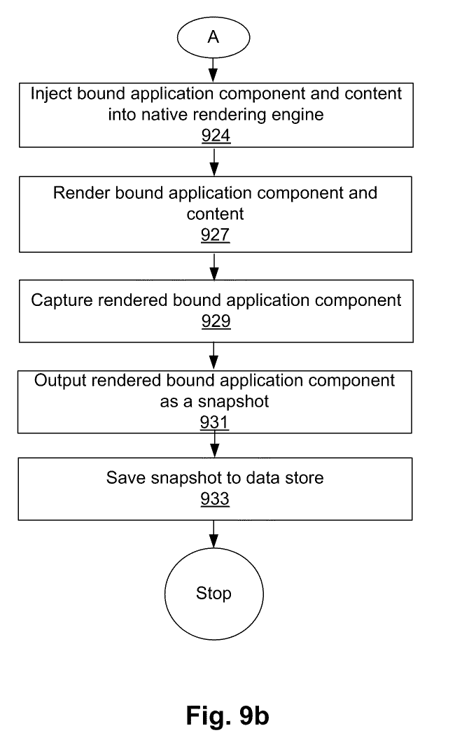

FIGS. 9a-b is a more detailed method for generating dynamic application content through the use of application markers (1) according to one embodiment of the invention. The application embedding engine (10) creates (900) content responsive to user input. The application embedding engine then retrieves (901) an application snapshot. The application embedding engine (10) captures (903) an application marker from the application snapshot (64) and embeds (906) the application marker into content. The content and application preview module (13) renders (907) an application marker and content to generate a preview.

A distribution engine (30) transmits (909) the application marker and content to a dynamic application engine (38). The dynamic application engine (38) identifies the application marker (911), binds (913) the application marker to a functional component and associates (916) the functional component with application logic. A custom rendering engine (52) injects (924) the bound application component and content into a native rendering engine (51). The native rendering engine (51) renders (927) the bound application component and content.

An application marker output module (60) outputs (931) the rendered bound application components as a snapshot. The snapshots are saved (933) to a data store. When a user wants to modify the application, the snapshot is retrieved and the method is repeated.

### I. Operation of One Embodiment

A preferred embodiment of this invention described throughout this section utilizes Microsoft C#.Net, Microsoft SQL Server, Microsoft ASP.Net, Web Services, Xml and Xslt based technologies.

The content editing and application embedding engine (10) is a Windows desktop (WinForm) based application written in Microsoft C#.Net and utilizes Xslt technologies to support application embedding using the application embedding module (12) and display simulation using the content application and preview module (13) while using web services and Microsoft.Net libraries to support compression using the creation tools module (14) and saving to the content data store (20).

The content data store (20) utilizes Microsoft SQL Server to store and retrieve content and application definition files created by the content editing and application embedding engine (10).

The distribution engine (30) is a Microsoft Windows Service written in Microsoft C#.Net that is scheduled to push content from Microsoft SQL Server to the sub folders of the Microsoft ASP .Net web application where they are utilized by the application processing module (40) and the application assembly and display module (50).

Finally, the application processing module (40) and the application assembly and display module (50) are Microsoft C#.Net class libraries written to supplement the rendering, processing and display functionality of a dynamic Microsoft ASP.Net web application so that the content and application definition files created by the content editing module (11) can be utilized by the Microsoft ASP.Net web application.

To begin the content and application definition file(s) life cycle, the user first opens the content editing and application embedding engine (10) and begins developing “content”. Content is defined as images, Html, css, JavaScript, Xslt, Xml, application markers, application definition files and any other content a user might supplement the display of their final application with like sound files, movie files, word documents, pdf files, etc.

The process of developing content begins by selecting a page definition associated with the target application from the navigation menu of the content editing and application embedding engine (10). Once a page has been selected, the user can switch between two views of the page. One view is used for editing the content and one view is for simulating how the content would appear in its target ASP.Net application.

During the process of developing and previewing content, a user can add application markers to their content. Application markers are references to functional components within their target dynamic application. For example, a user name text box is an application marker associated with logging into the target application. This user name text box performs actual work within the target dynamic application when it is present (it collects the user name). This application marker will be replaced by a snapshot (64) of the user name text box during a simulated preview and by the true user name text box when the content is distributed to the target dynamic application and displayed.

Once the content developer is satisfied with the changes to their content, they publish their content to the content data store (20). During this process their content is packaged and compressed by the creation tools module (14) to minimize storage requirements. All content and application definitions are stored in the content data store (20), including images, Html, Xml, Xslt, css and sound files.

The content data store (20) is centrally located to the application processing module (40) and the content and application assembly and display module (50) so content can easily be distributed to them by the content and distribution engine (30).

Once content is compressed and stored by the creation tools module (14) in the centrally located content data store (20), the distribution engine (30) will periodically retrieve, decompress, and distribute the stored content and definitions to the location of the application processing module (40) and the content and application assembly and display module (50).

When a request is made to the ASP.Net web application by an end user, the application processing module (40) is responsible for identifying application components relevant to the request and binding those application components to the ASP.Net page context. This is done by analyzing application definition files and content that were published to it by the distribution engine (30).

Finally, the content and application assembly and display module (50) finalizes the ASP.Net web application user's request by gathering relevant content for the user's request, rendering bound application components and passing the results to the underlying ASP.Net web application's native rendering routines for output to the end user.

During the custom rendering process of the application assembly and display module (50), the interim content and bound application components are intercepted, wrapped in XML tags and output as snapshots to Xml files that are rigidly named and ready for consumption by the content editing and application embedding engine (10).

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

1. A method executable by a processor of a computer for managing content, the method comprising:
creating content responsive to user input;
retrieving an application snapshot from a data store;
capturing an application marker from the application snapshot;
embedding the application marker into the content;
binding the application marker to a functional component to generate a bound application component;
rendering the bound application component and content to generate a rendered bound application; and
outputting the rendered bound application components.

2. The method of claim 1, further comprising:
identifying the application marker.

3. The method of claim 1, further comprising:
associating the functional component with application logic.

4. The method of claim 1, further comprising:
rendering the application marker and content to generate a preview.

5. The method of claim 1, wherein the rendered bound application components are retrieved directly from the dynamic application at runtime.

6. The method of claim 1, further comprising the step of:
wrapping the rendered bound application component.

7. The method of claim 1, further comprising:
retrieving the rendered bound application components; and
capturing a modified application marker from the rendered bound application components.

8. The method of claim 1, wherein the method is performed using a Windows desktop based application.

9. The method of claim 1, wherein the embedding step is performed using eXtensible Stylesheet Language Transformations.

10. The method of claim 1, further comprising the step of capturing the rendered bound application component.

11. A content management system for generating a dynamic application comprising:
an application embedding engine configured to generate content responsive to user input and embed the application snapshot in the content;
a distribution engine coupled to the application embedding engine, the distribution engine configured to transmit the content and the application marker to a dynamic application engine;
the dynamic application engine coupled to the distribution engine, the dynamic application engine configured to identify the application marker, bind the application marker to a functional component to generate a bound application component, render the bound application component and content and output the rendered bound application component as a snapshot.

12. The system of claim 110, wherein the application embedding engine comprises a creation tools module that is coupled to a content data store, the creation tools module for compressing the application marker and the content.

13. The system of claim 12, wherein the distribution engine comprises a content decompression module that is coupled to the content data store, the distribution engine for decompressing the compressed application marker and the compressed content.

14. The system of claim 11, further comprising a content data store coupled to the application embedding engine and the distribution engine, the content data store configured to store the application marker and the content.

15. The system of claim 11, the application embedding engine further comprising a content and application preview module configured to render the application markers and content to generate a preview.

16. The system of claim 11, wherein the dynamic application engine is further configured to associate the functional components with application logic.

17. The system of claim 10, wherein the system operates on a Windows desktop based application.

18. The system of claim 10, wherein the application embedding application is configured to retrieve an application snapshot.

19. The system of claim 10, wherein the design and publishing engine comprises an application embedding module for embedding eXtensible Stylesheet Language Transformation tags into the content.

20. The system of claim 10, wherein the dynamic application is assembled at runtime.
